(19) United States
(12) Patent Application Publication
(10) Pub. No.: US 2011/0117760 A1
(43) Pub. Date: May 19, 2011

(54) ELECTRICAL BOX

(75) Inventors: Nathan B. WINSTANLEY, Lenox, MA (US); Brendan M. WALSH, Pittsfield, MA (US); Philip A. COHEN, Richmond, MA (US); Ashok Alilughatta SATHYANARAYANA, Pune (IN); Chandrakanthtrao GIREESHRAO, Cary, NC (US); Ralph Michael CIRONE, Raleigh, NC (US); Robert Alan KROSKY, Raleigh, NC (US)

(73) Assignees: WINSTANLEY PARTNERS, Lenox, MA (US); SIGMA ELECTRIC MANUFACTURING CORPORATION, Garner, NC (US)

(21) Appl. No.: 12/939,386

(22) Filed: Nov. 4, 2010

Related U.S. Application Data
(60) Provisional application No. 61/261,979, filed on Nov. 17, 2009.

(51) Int. Cl. H01R 13/44; H01R 29/00

(52) U.S. Cl. 439/136; 439/188

(57) ABSTRACT

In one embodiment, a female electrical connector comprises a socket having slots and electrical contacts. At least one of the electrical contacts can be movable between an open electrical circuit position where the electrical contacts are not in electrical communication and the socket is electrically inactive and a closed electrical circuit position where the electrical contacts are in electrical communication and the socket is electrically active. In one embodiment, an electrical box can comprise a container formed from a base having sides extending therefrom to define a cavity and the female electrical connector.

### CROSS REFERENCE TO RELATED APPLICATIONS

This application claims priority to Provisional Patent Application No. 61/261,979, filed Nov. 17, 2009, and incorporated herein in its entirety by reference.

### BACKGROUND

Wiring boxes for containing electrical outlet connections are known and typically include a housing with one or more plug receptacles for insertion of standard electrical plugs based upon either the country and/or the voltage. Wiring entering an outlet box is typically connected to a particular electrical fixture or receptacle (female electrical connector) such as a lighting fixture, electrical outlet, or switch.

There have been many developments directed to the safety of the electrical outlet. For example, outlet cover(s) have been designed to be located over a receptacle such that a plug cannot be inserted through the cover into the receptacle without aligning the openings in the cover with the receptacle slots. Another safety product is a non-electrically conductive cap that can be inserted into the receptacle slot, thereby inhibiting the insertion of any other object. Even though these solutions have been somewhat effective. There remains a need for further improvements and alternatives in receptacle safety.

### BRIEF SUMMARY

In one embodiment, a female electrical connector comprises a socket having slots and electrical contacts. At least one of the electrical contacts can be movable between an open electrical circuit position where the electrical contacts are not in electrical communication and the socket is electrically inactive and a closed electrical circuit position where the electrical contacts are in electrical communication and the socket is electrically active.

In one embodiment, an electrical box can comprise a container formed from a base having sides extending therefrom to define a cavity and a female electrical connector comprising a socket having slots; and a switch, wherein the switch is configured to engage and disengage an electrical current to the socket while the electrical box remains electrically active.

In another embodiment, a method for providing electricity to a male electrical connector comprises: inserting prongs of a male electrical connector into a socket of a female electrical connector, wherein the female electrical connector is connected to an electrical box, wherein the electrical box is electrically active and wherein the socket is electrically inactive; and then electrically activating the socket.

The disclosure can be understood more readily by reference to the following detailed description of the various features of the disclosure and the examples included therein.

### BRIEF DESCRIPTION OF THE DRAWINGS

Refer now to the figures, which are exemplary embodiments, and wherein the like elements are numbered alike.

FIG. 1 is a side view of an embodiment of the electrical box.

FIG. 2 is a side view of an embodiment of the electrical box.

FIG. 3 is a side view of the electrical box connected to the wall.

FIG. 4 is an exploded side view of the disassembled electrical box.

FIG. 5 is a side view of the assembled electrical box.

FIG. 6 is side view of an embodiment of a receptacle wherein the receptacle in the inactive position, so the socket is electrically inactive.

FIG. 7 is a side view of the receptacle of FIG. 6 being moved between the inactive and the active positions; e.g., the electrical circuit is being closed.

FIG. 8 is a side view of the electrical receptacle of FIG. 6, wherein the receptacle is in the active position; e.g., the electrical circuit is closed and the socket is electrically active.

FIG. 9 is a front view of an embodiment of the electrical box with an open cover.

FIG. 10 is a front view of an embodiment of the electrical box with a closed cover.

FIG. 11 is a front view of an embodiment of the electrical box with an open cover.

FIG. 12 is a front view of an embodiment of the electrical box with a closed cover.

FIGS. 13-14 are perspective, cut away, front and side views of an embodiment of the electrical box illustrating the employment of electrically conductive coiled wires.

FIGS. 15-18 are various perspective and side views of an embodiment of the electrical box illustrating an external switch.

FIG. 19 is a front view of an embodiment of a receptacle.

FIG. 20 is a front view of the receptacle of FIG. 19 including a face plate.

FIG. 21 is a front view of another embodiment of a receptacle comprising open electrical circuit and closed electrical circuit configurations.

FIG. 22 is a side view of the receptacle of FIG. 21.

FIGS. 23-25 are side views of other embodiments of receptacles comprising different power engaging and disengaging mechanisms.

FIG. 26 is a front view of yet another embodiment of a receptacle comprising interruptible electrical connection.

### DETAILED DESCRIPTION

The electrical boxes described herein comprise current interruption which provides safety advantages therefore, i.e., the electrical socket can be electrically inactive when it is accessible for receiving a plug or other object and electrically active (“live”) when a plug is connected to the socket. Electrical boxes generally comprise a receptacle; i.e., a female electrical connector comprising slots in a socket for receiving and delivering current to prongs (also known as pins, blades, and the like) of an inserted plug. When in use, an electric plug (i.e., a male electrical connector comprising contact prongs that connect mechanically and electrically with the slots of the female electrical connector), is disposed in electrical and mechanical communication with the receptacle.

In various embodiments, the current interruption described herein refers to the female electrical connector (e.g., one or all sockets) being electrically inactive (e.g., not “hot”; electrically disconnected; “dead”) either when the slots of the receptacle are accessible and/or before the prongs of a plug have been inserted into the socket. For example, when the receptacle is accessible (e.g., able) to receive an electric plug, the receptacle is not live (i.e., no current can flow from the receptacle). When the male electrical connector (plug) is received in the socket of the receptacle, the socket (and/or the entire receptacle) becomes live (“hot”; electrically connected) and current can flow to the plug. When the plug is removed from the socket, the socket can again become inactive. In some embodiments, the socket and/or entire receptacle do not become live until the plug cannot be removed from the socket and/or do not become live until the plug is fully engaged with the socket. For example, the socket does not become live until the cover to the junction box is closed, inhibiting removal of the plug from the socket. Alternatively, or in addition, the socket does not become live until at least one prong of the plug is fully engaged in the socket (i.e., fully inserted into the socket), and/or multiple prongs are fully inserted into the socket.

In one embodiment, when a cover for an electrical junction box is in an open position, the plug receptacle is inactive, i.e., no electrical current is available; the socket is not in electrical communication with an electricity source. When the cover is in a closed position, the receptacle is active, thereby enabling the flow of electricity to the plug. Optionally, in the closed position, the cord and plug (e.g., the prongs of the plug) can be parallel to, and/or in line with, the electrical box base (see FIG. 3), thereby decreasing the electrical box side profile at least by the width of the plug and the cord as compared to the plug being in a perpendicular position to the electrical box base.

In this embodiment, when the cover is in an open position, no electricity flows to the receptacle. This feature ensures that when the user is inserting an object into the receptacle, the receptacle is inactive; no electricity can flow through the receptacle into the object. In order to enable electrical connection between the junction box and the plug and cord, the plug is inserted into the receptacle, the cover is closed, enabling the electrical connection and allowing electricity to flow to the socket and therefore, through the plug and cord. The connection enabling/disabling the electrical connectivity (e.g., electrically enabling/disabling the socket and/or the whole receptacle) can be accomplished via a switch, the receptacle and/or the cover. For example, the electrical box can comprise a switch that is on an exterior surface, accessible when the lid is in the closed position. This switch can enable and disable the flow of electricity to the receptacle and hence the plug. Such an arrangement would enable one to turn on/off all appliances (e.g., radio, temporary light, exterior device) receiving power from the electrical box, without removing the plug or using a switch on each appliance.

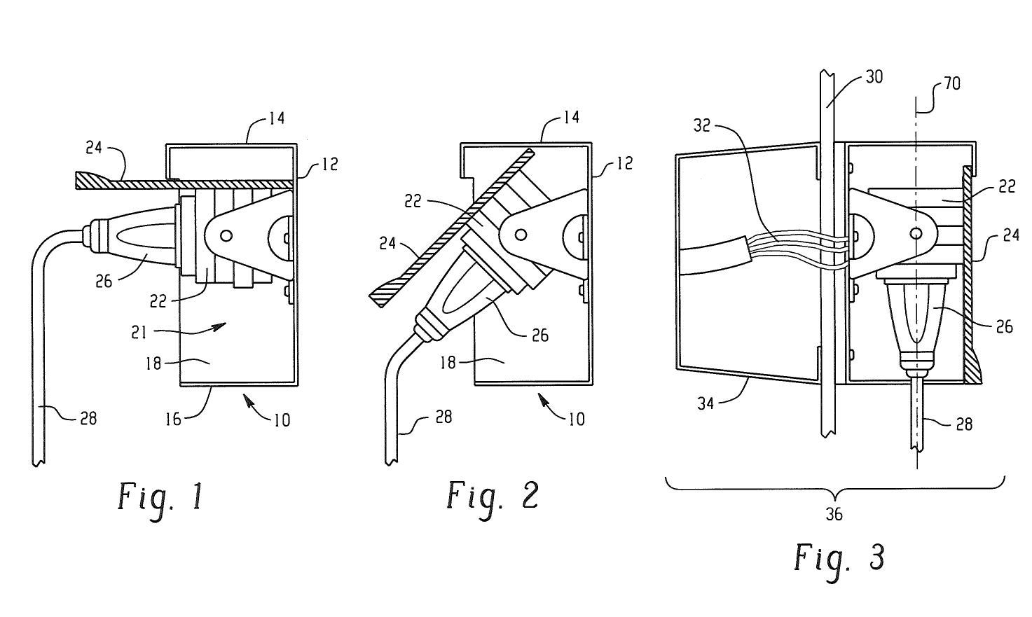

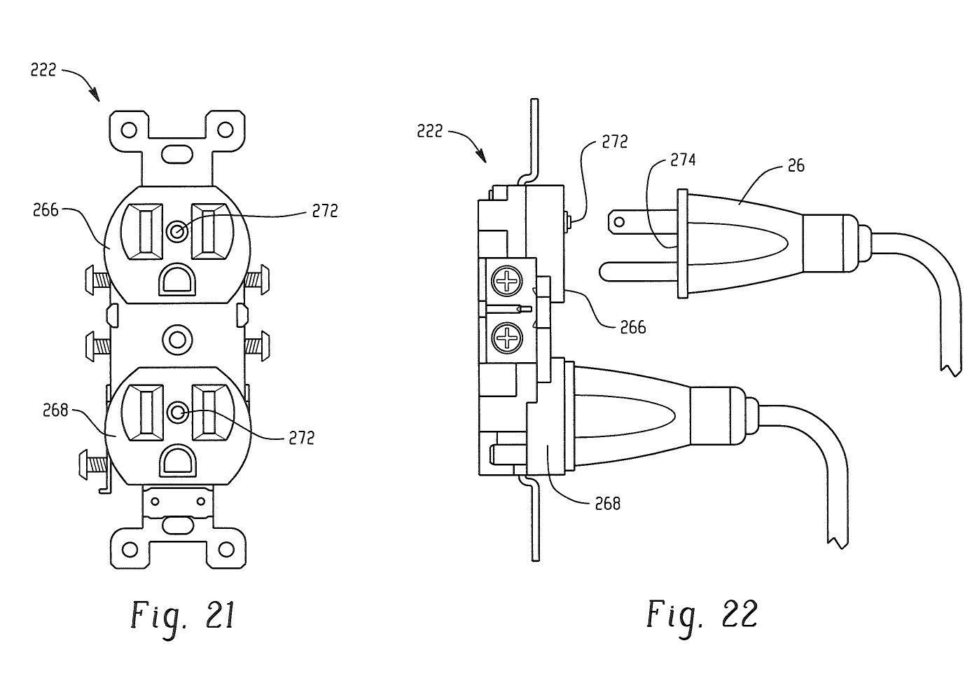

In various embodiments, the receptacle can comprise various mechanical, electrical, and/or electromechanical switches that engage and disengage an electrical connection between individual socket(s), and/or the entire receptacle, and a power source. The switch can be an external switch (e.g., a switch that is accessible to a user such as on an outside surface of a receptacle and/or socket (e.g., see FIG. 21)), an internal switch (i.e., a switch that is located within the receptacle or electrical box, not on a surface thereof; not directly accessible to a user (e.g., see FIGS. 1, 9, 13, 19, 23, 24, and 25)), or a combination comprising external switch(es) and/or internal switch(es). For example, socket(s) (and/or receptacle(s)) can be configured to: (i) have mechanical contact with prong(s) before the socket (or entire receptacle) is electrically active (e.g., “engaged”); (ii) use prong(s) to engage a switch (e.g., spring switch, contact on a cam, and so forth), that enables the current flow to the socket (or entire receptacle); (iii) sense the prongs (e.g., a magnetic switch); and/or (iv) use mechanical movement to enable the engagement of contacts (e.g., relative motion can be created between two contacts such that they open or close the circuit, accordingly). For example, even though the power to the electrical box is live (current is supplied to the electrical box), and an object is inserted into the receptacle, if the object does not mechanically communicate with the particular switch in the correct fashion, current cannot flow to the object. For example, even though the power to the electrical box is live (current is supplied to the electrical box), and an object is inserted into the receptacle, if the objects are not inserted into one, or multiple, or all, of the slots, and/or are not inserted sufficiently far into the slot(s), the receptacle remains inactive and current cannot flow through the socket to the object (e.g., see FIGS. 22, 24, and 25).

In some embodiments, the receptacle slots can be restricted, e.g., with a cover, blockage, or the like, that prevents insertion of a plug or other object into the receptacle. When the restriction is mechanically removed, the removal action also opens the circuit, disengaging current to the socket(s) and/or to the entire receptacle. Once the plug has been inserted into the socket, the mechanical action can cease, thereby allowing the circuit to close and enabling the flow of electricity to that plug. For example, applying force to an engagement element can remove the restriction, enable access to the slots of the socket, and open the circuit (thereby disengaging the socket from the electricity source). While the force is applied, the receptacle is electrically inactive and the slots are accessible. Once the prongs of a plug are inserted into the slots, the force can be removed (e.g., discontinued), thereby closing the circuit and enabling the current to flow to the plug. (See FIG. 26) Some exemplary engagement elements, both contact and non-contact types, include a button, switch, lever, and so forth, as well as combinations comprising at least one of the foregoing.

A first embodiment is shown in FIGS. 1-3 comprising a base 10 having a rear section 12, a first side 14, a second side 16, a third side 18, and a fourth side (not shown) that define a perimeter, forming cavity 21. A cover 24 operably communicates with the base 10. Optionally, the receptacle 22 can be hingedly connected to the cover 24 so that when the cover 24 is in an open position (FIG. 1), the receptacle 22 is electrically inactive and no electricity can flow to the receptacle 22. The receptacle 22 is located in the cavity 21 of the base 10. A plug 26 having a cord 28 can be inserted into the receptacle 22 when the cover 24 is in an open position. Optionally, the plug 26 and cord 28 can be perpendicular to the electrical box 10 when the cover 24 is in an open position. When the cover 24 is closed, the receptacle 22 becomes active and electricity can flow to the receptacle 22 and plug 26 (FIG. 3).

FIG. 2 illustrates an embodiment when the cover 24 is in the process of being closed. The receptacle 22 is still inactive until the cover 24 is closed. Once closed, the receptacle is electrically connected to a power source. Activating the receptacle can be accomplished in various fashions such as: (i) as the cover 24 closes, electrical contacts on the receptacle and box come into contact with one another, wherein when the cover opens, the receptacle contact moves out of contact with the box contact; (ii) once the cover is closed, a switch on the cover, base, or box, can be moved to the “on” position, wherein, when the cover is open, the switch automatically moves to the off position, the “on” position is disabled, and/or the box cannot be opened if the switch is in the “on” position (i.e., when electricity can flow to the receptacle and a plug located therein); and/or (iii) the receptacle remains stationary with respect to the cover, and when the cover opens, a non-electrically conductive component (e.g., dielectric shim), disrupts the electrical connectivity between the receptacle and the wiring (e.g., the component moves between the contacts).

In some embodiments, as is illustrated in FIG. 3, once the cover 24 is closed, the plug 26 and cord 28 are parallel with the electrical box, thus creating a decreased side profile. In other words, the cord exiting and the box are in a common axis 70 with the receptacle slots (e.g., as opposed to being substantially perpendicular as is generally the case with while-in-use covers). In the embodiments where the receptacle 22 is pivotably engaged with base 12, as well as other embodiments, the side 16 can have an opening that is large enough to enable the cord to pass therethrough, yet too small to allow the plug to pass therethrough.

Within the electrical box can be standard and/or custom wiring connections, outlet connectors, and/or switches. For example, the electrical box can have a 110 volt, two pronged, non-grounded or two prong, three hole, grounded outlet, which can have multiple receptacles (e.g., located side by side), within the box or 220 volt outlet receptacle(s). It is noted that although the figures are illustrated with a standard three prong plug and associated socket, the present concept applies to any plug and socket configuration. For example, the present concept can be applied to sockets for alternating current and/or direct current, including those sockets fitting European, Asian, North American standards, as well as combinations comprising at least one of the foregoing and equivalents thereof. Some possible sockets and plugs include British Engineering Standards Association (BESA) plugs and sockets, National Electrical Manufacturers Association (NEMA) plugs and sockets, as well as other plugs and sockets, and combinations comprising at least one of the foregoing. Some examples include NEMA Type 1-Type 13, NEMA Type A-Type M, as well as combinations comprising at least one of the foregoing and equivalents thereof, e.g., IEC equivalents.

In FIG. 3, the electrical box 10 is attached to a wall 30 (e.g., building wall). Wires 32 are connected to the receptacle 22 through a container (e.g., electrical junction box) 34 mounted into the wall 30. The electrical box assembly 36 is shown with the cover 24 in a closed position such that the plug 26 and cord 28 are parallel with the side of the electrical box 10 and the receptacle 22 is active (i.e., electricity can flow through the electrical box 10 is a load is placed on the plug and cord; the plug 26 is in electrical communication with the wires 32).

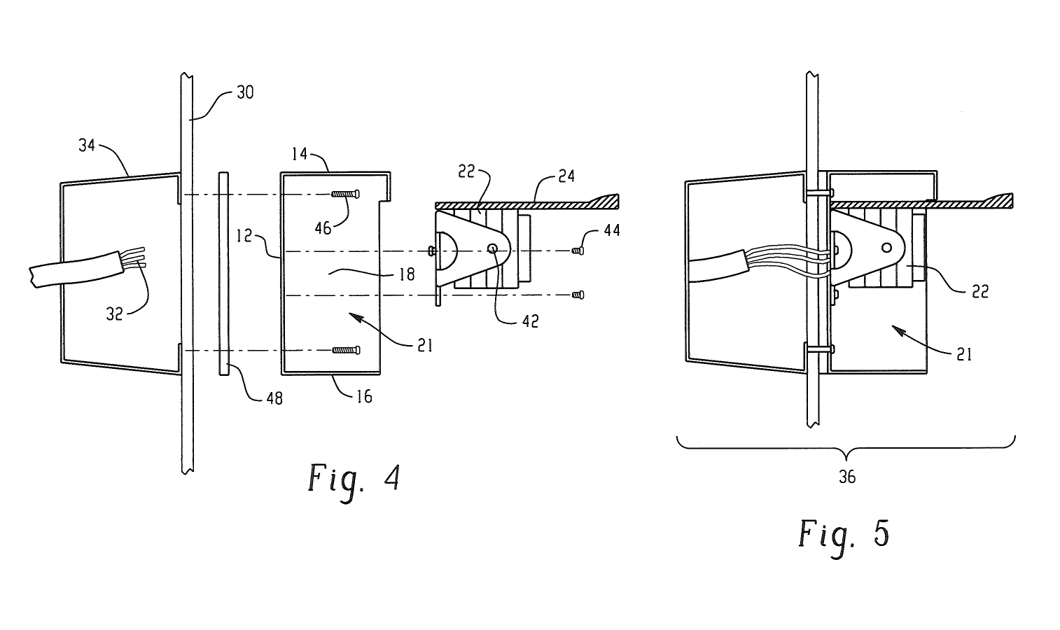

FIG. 4 provides an exploded view of the electrical box assembly 36 disassembled. The container 34 can be seen with the wires 32 passing therethrough. The container 34 is installed in a wall 30 awaiting the electrical box section defining a cavity 21. A clapboard spacer 48 can be located between the junction box 34 and the rear section 12 such that the base 10 can be mounted to the electrical box 34 via mounting screws 46. As can be seen, the receptacle 22 can be attached to the cover 24 such that the receptacle 22 and cover 24 can be hingedly attached to the base 10. The central point 42 on which the receptacle 22 rotates is also located in this region along with a pair of finishing screws 44. In FIG. 4, the cover 24 is open so that no electricity or current flows to the receptacle 22. FIG. 5 shows a fully assembled view of the electrical box 10 and the container 34 attached to the wall panel 30. In FIG. 5 the cover 24 is in an open position, meaning that no electricity is flowing to the receptacle 22.

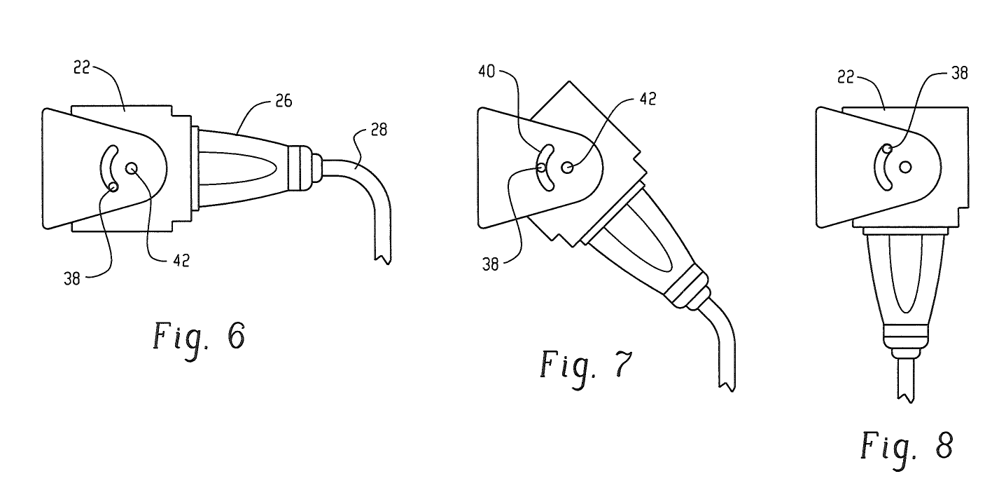

Turning now to FIGS. 6, 7, and 8, one embodiment of the operation of the receptacle is illustrated. In FIG. 6, the cover 24 (not shown) is in an open position with the plug 26 inserted into the receptacle 22 and fully engaged. In this position, no electricity is flowing to the receptacle 22 or plug 26. As shown in FIG. 6, a ball bearing 38 (e.g., a spring loaded ball bearing) is in a resting state, breaking electrical contact, and thus stopping current from flowing to the receptacle 22. FIG. 7 shows the receptacle 22 with the plug 26 inserted and fully engaged, and in motion, rotating on a central point 42 while the ball bearing 38 travels on a grooved path 40 in route to the activating position. FIG. 8 demonstrates the ball bearing 38 in place so as to establish electrical communication with the wiring and enabling the flow of current to the receptacle 22. In this position, the cover 24 closed (not shown) with the plug 26 and cord 28 fully rotated on the central point 42 and in parallel position with the side of the box. When the cover is reopened, the ball bearing 38 moves along groove 40, disengaging electrical communication between the receptacle and wiring and rendering the receptacle inactive.

In some embodiments, the receptacle is stationary and the cover moves independently of the receptacle. In these embodiments, the opening and closing of the cover can still disengage and engage, respectively, the electrical communication between the receptacle and the electricity source. For example, the cover can move independently of the receptacle (the receptacle remains in the cavity as the door opens). In other words, motion of an element of the electrical junction box assembly (e.g., the cover, cover assembly, receptacle, and/or another element of the outlet kit, can be employed to electrically activate and deactivate a receptacle; i.e., open and close the electrical circuit. The motion can be rotational and/or linear, e.g., sliding, such as, around, in/out, up/down, back/forth, as well as a combination comprising at least one of the foregoing motions, and can be in a direction appropriate for the particular electrical box assembly.

Additionally, the cover opening and closing of the circuit can be used in combination with other solutions, e.g., one or more switches disclosed herein. In other words, the insertion of prongs of a plug into a receptacle can enable the socket to be active. However, until the cover is closed, the socket still remains inactive. Similarly, if the prongs of the plug are not inserted into the socket, even if the cover is closed, the socket is inactive. In this embodiment, the combination of the switch and the cover control the opening and closing of the circuit.

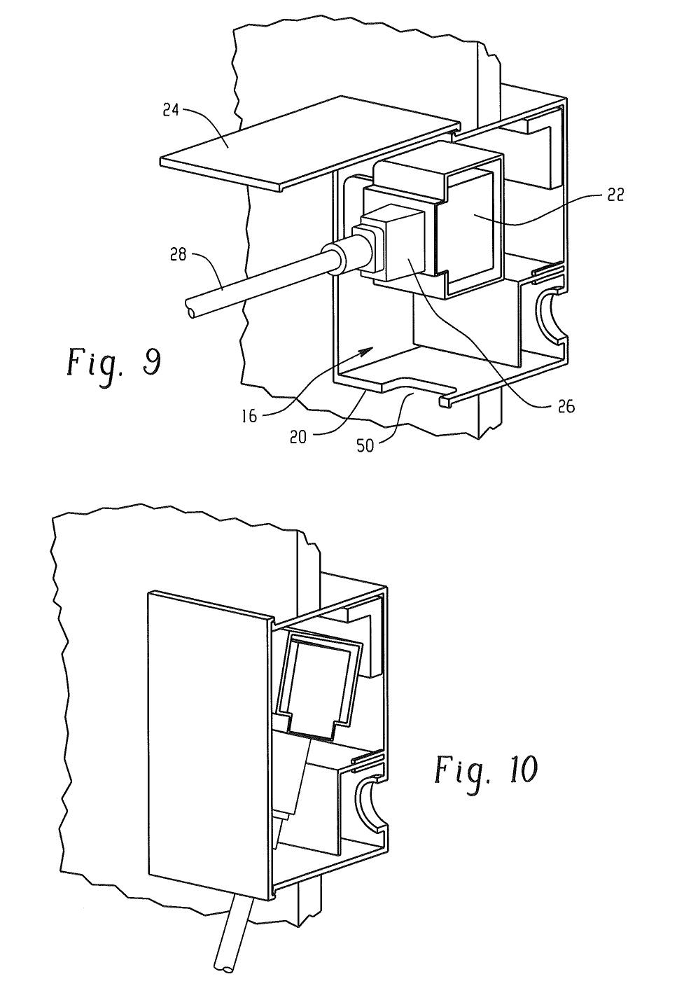

FIGS. 9 through 12 further illustrate embodiments of the electrical box 10. In FIG. 9, a receptacle 22 is shown with the plug 26 and cord 28 fully inserted. In FIG. 9, the cover 24 is open. As the cover 24 is closed, the receptacle 22 rotates with the plug 26 and cord 28 to one side and toward side 20 and opening 50 such that, in the closed position, the cord 28 passes through the opening 50. Once the cover 24 is closed, current can flow to the receptacle 22 such that power can be delivered via plug 26 and cord 28.

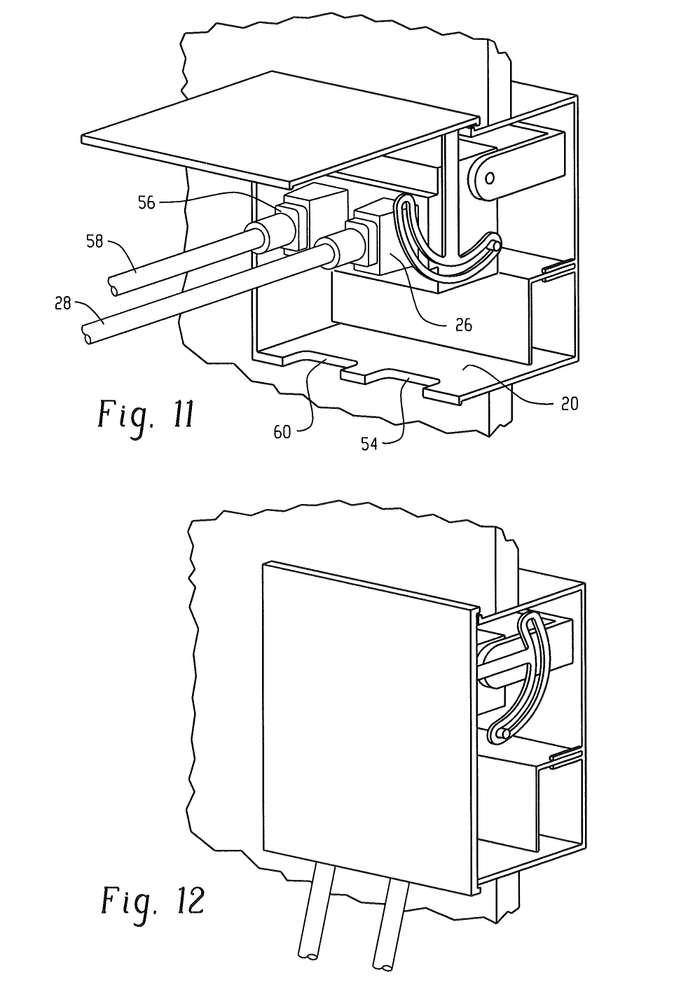

As shown in FIG. 11, in which a double receptacle 52 is illustrated, the electrical box can have one or more receptacles. FIG. 11 shows a receptacle 54 with plugs 26, 56 and cords 28, 58. As with FIG. 9, the cover 24 is open and multiple openings 54, 60 are located in side 20 of the electrical box. In FIG. 12, as the cover 24 is closed, the receptacle 22 rotates the plugs, 26, 56 and cords 28, 58 to one side and toward side 20. The cords 28, 58 engage with the openings 54, 60 in side 20. Once the cover 24 is closed, current flow to the receptacles. The cover 24 can be designed such that the fit between the cover 24 and the electrical box 10 is close enough to inhibit, and even prevent, water transmission into the electrical box 10 when the cover 24 is in a closed position as long as the electrical box is not partially or fully submerged in water.

The electrical box 10 can be mounted horizontally or vertically (e.g., if the electrical box is not square, the longest side of the box can be disposed vertically or horizontally). Additionally, one or multiple gang boxes are contemplated. It is further noted that the cover can open horizontally, vertically, or on an angle (e.g., diagonally), so long as the current flow to the receptacle(s) is ceased when the cover is in the open position and enabled when the cover is in the closed position (e.g., opening of the cover disrupts current flow to the receptacle(s) in the box). It is noted that it is also contemplated that the disruption in current flow is based upon the movement of the receptacle. For example, when the cover is opened, the spring loaded receptacle automatically moves to a disengaged position such that no electrical current flows the receptacle. In other embodiments, the receptacle(s) can be stationary and the cover (or an element associated with the cover) engages and disengages the electrical current (e.g., ceases the electrical communication with the receptacle).

In one embodiment, the electrical box 10, including the base 12 and container 34, comprises a rigid formable material such as a cast metal (e.g., aluminum or other metal alloy) that is suitable for casting and allows for intricate details, strength, and conductivity (if required for the particular application being used). In another embodiment, the electrical box 10, including the base 12 and container 34 can be made of an injection moldable grade polymer. The injection moldable grade polymer may include a conductive filler or combination of electrically conductive fillers (if conductivity is required for the particular application being used) as well as fiber reinforcement if more structural strength (i.e., a stiffer part) is required.

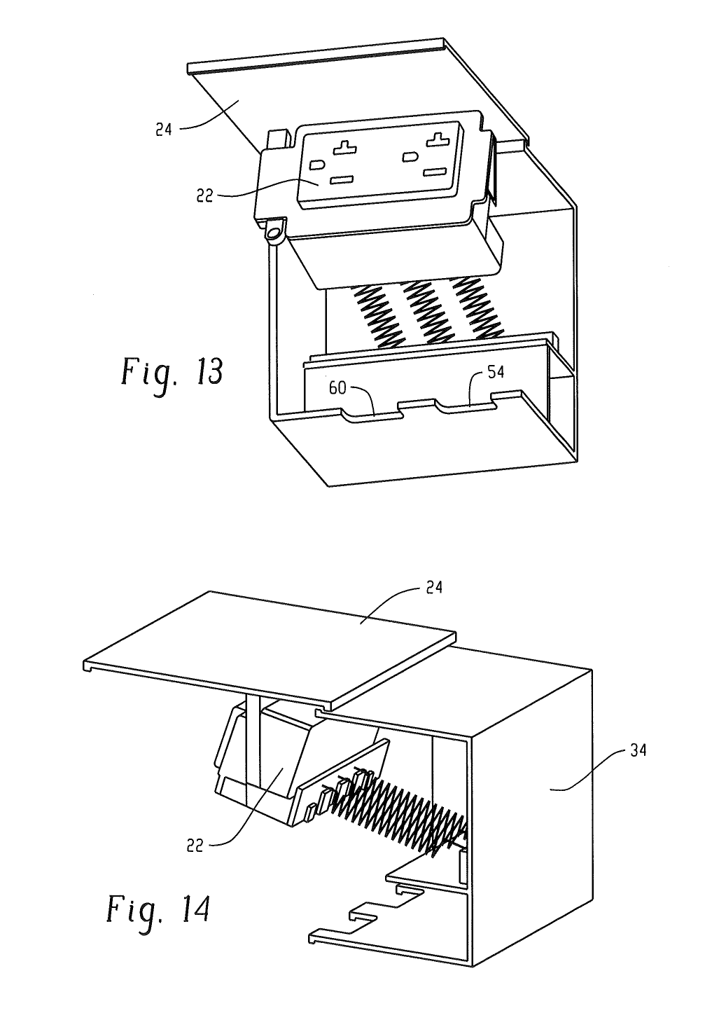

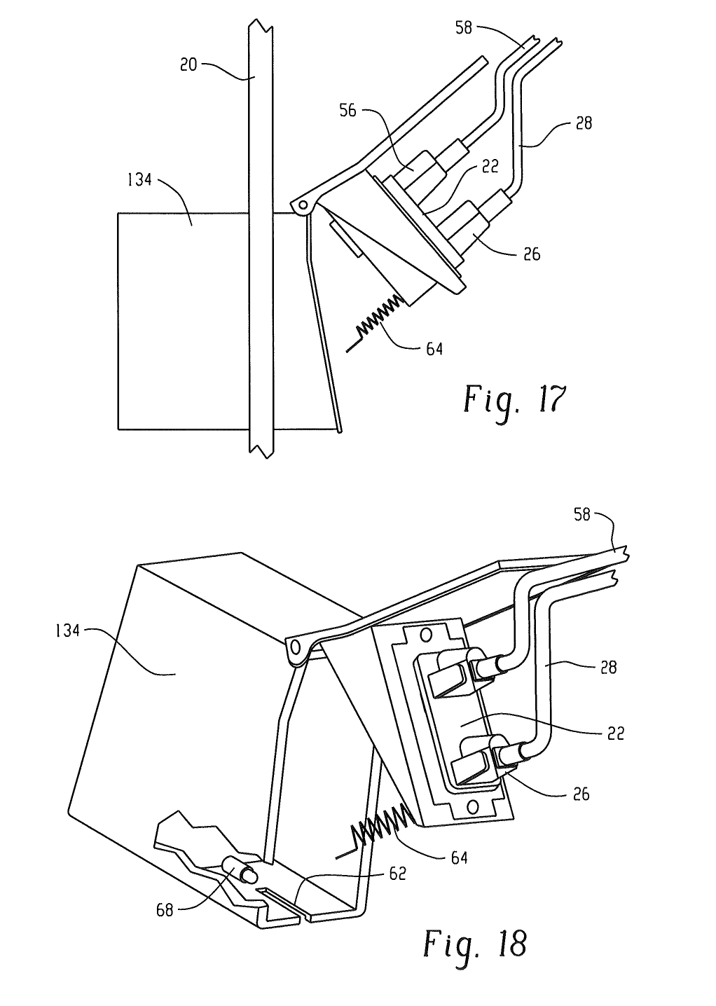

The embodiments illustrated in FIGS. 13-18 show different angles of an electrical box 134 wherein an electrically conductive wire 64 is connected to the receptacle. The wire 64 (e.g., a coiled wire) can sufficiently flexible and elastic (spring-like) to enable the cover 24 to be opened and the receptacle to move out of the box 134 without the need to disconnect wires. In this embodiment, the cover is pivotally connected directly to the junction box that can be inserted into the wall 20.

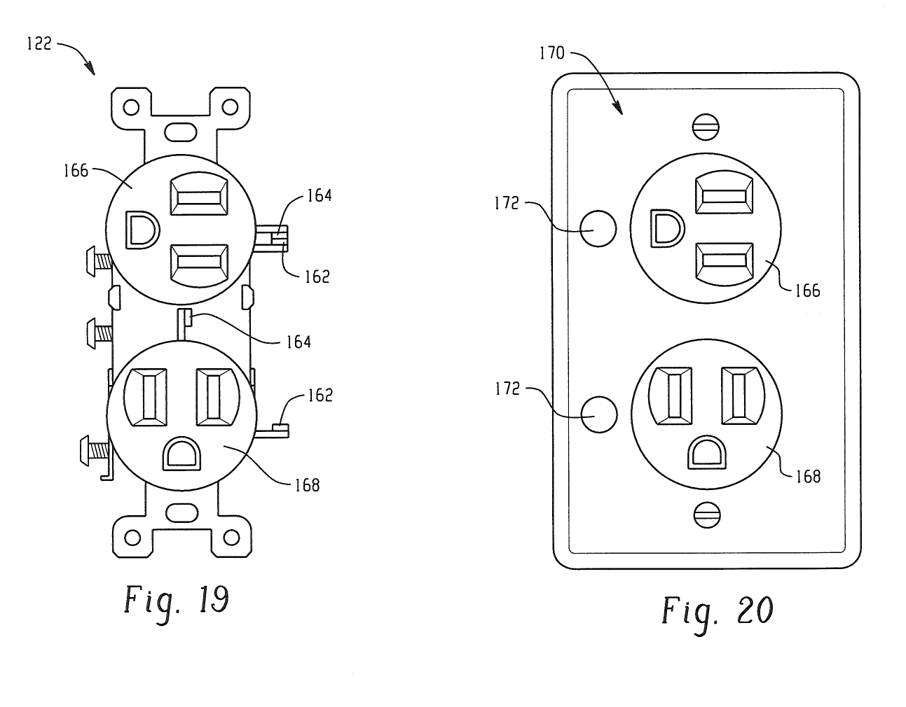

FIGS. 19-26 illustrate exemplary embodiments that employ a switch to open and close the electrical circuit to the socket(s). FIGS. 19 and 20 comprise a receptacle 122 having sockets 166, 168, and contacts 162,164. Socket 168 illustrates the contact separated, i.e., the open circuit. Socket 166 illustrates the contacts 162,164 together, in physical and electrical communication, i.e., the circuit closed. Therefore, when a plug is inserted into the socket 166 and relative motion is created between the contacts 162 and 164 to bring the contacts together, the circuit is closed and the socket becomes active. Here, the relative motion can, for example, be the rotation of the socket. Optionally, the socket can comprise a lock that prevents the relative motion of the contacts if the correct plug is not inserted into the socket. For example, a spring lock can be engaged with the socket when no plug is inserted, and can be disengaged by the insertion of a plug into the socket. When the spring lock is disengaged the relative motion can be achieved and the electrical circuit can be closed.

FIG. 20 further illustrates an exemplary cover plate 170 and visual indicator(s) 172. The visual indicator(s) can enable easy visual confirmation that a socket and/or receptacle is live (i.e., the electrical circuit is closed). A single visual indicator 172 can be used on a receptacle to identify when any socket in the receptacle is live. Alternatively, multiple visual indicators 172 can be used to identify when a specific socket is live.

FIGS. 21 and 22 illustrate another embodiment of a receptacle with a switch. This receptacle 222 comprises sockets 266, 268, and switch 272. The switch 272 is an external switch that closes the electrical circuit when a plug is inserted into the socket and engages the switch 272. For example, when the prongs of the plug 26 are inserted into the socket 266, the surface 274 of the plug 26 contacts the switch 272, exerting force on the switch 272, and moving the switch 272 toward the socket 266. When the switch moves into the socket 266, it causes contacts in the receptacle to engage and close the electrical circuit, making the socket 266 live. Although two switches 272 are illustrated, if desired, a single switch can be used to close the circuit for all sockets of the receptacle.

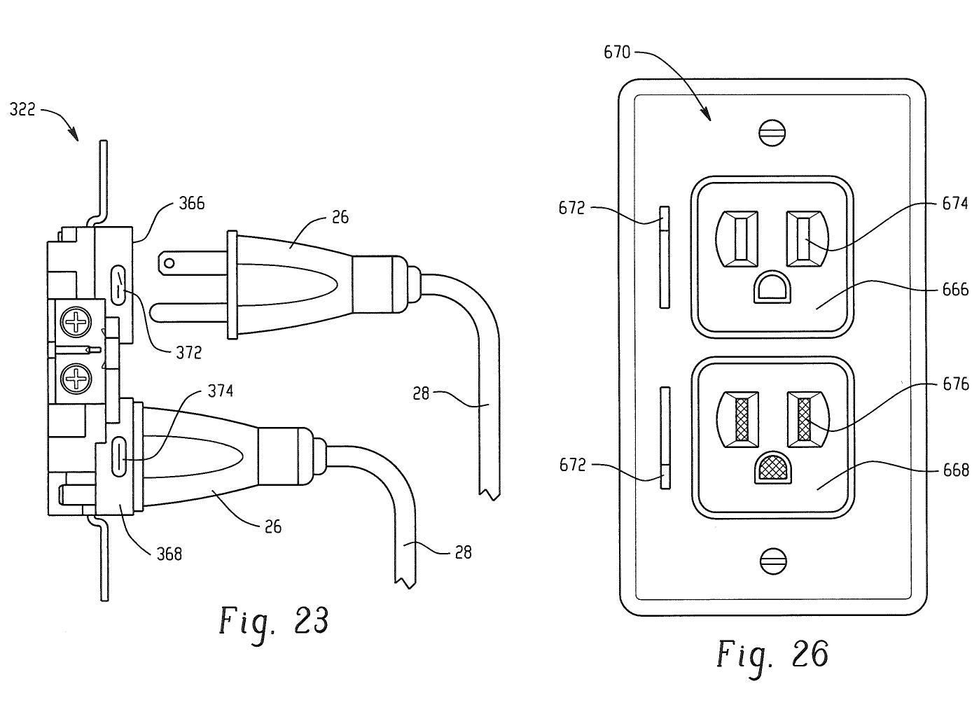

FIG. 23 is yet another illustration of an internal switch. In this embodiment, the receptacle 322 comprises sockets 366,368, and magnetic switches 372,374. Magnetic switch 372 is illustrated wherein the circuit is open; the plug 26 is not in the socket 366, while magnetic switch 374 is engaged (closed circuit) with the plug 26 located in the socket 368. For example, when the plug 26 is inserted into the socket 366,368, the magnetic switch 372,374, accordingly, senses the prongs and engages the circuit. A change in magnetic field activates a relay to make or break the contact and hence the circuit.

FIG. 24 illustrates the use of spring switch(es) to engage and disengage contacts 462/464,480/482 in the receptacle 422. As illustrated, a plug can be inserted into a receptacle. Relative motion is created between the contacts in the receptacle, causing the electrical circuit to close. For example, as the plug is inserted into the socket 466, the prongs 484 and/or 488 move the contacts 464 and/or 482 respectively, toward the contacts until the contacts 462 and 464 are in physical contact and/or contacts 480 and 482 are in physical contact. The closed circuit is illustrated with respect to socket 492, wherein the contacts 462 and 464 are in physical contact and the contacts 480 and 482 are in physical contact. The circuit can then be reopened, for example, by pushing the plug toward the contacts, causing the switch to release and the contacts to spring apart.

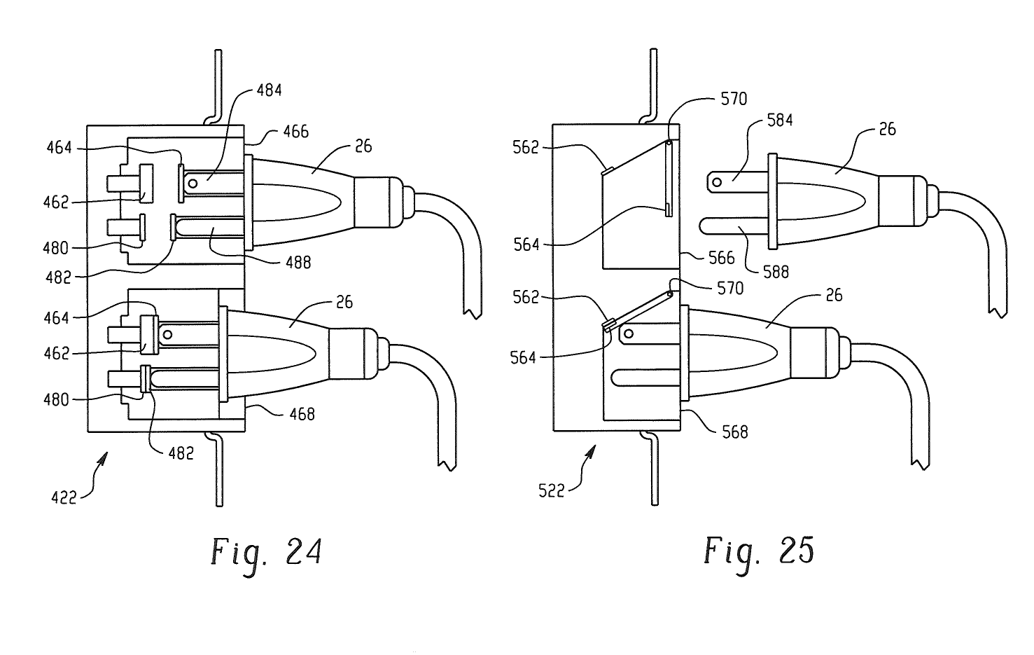

FIG. 25 comprises yet another embodiment of an internal switch. In this embodiment, the receptacle 522 comprises contacts 562,564 and sockets 566,568. The contact 564 is connected to a pivot 570 such that, when the plug 26 is inserted into the socket 566,568, the prongs 584 and/or 588 cause relative motion to be created between the contacts 562 and 564, thereby closing the circuit (the closed circuit is illustrated with the live socket 568). Similarly, when the plug is removed from the socket, relative motion is created between the contacts (e.g., with a spring, gravity, or the like), causing the contacts to physically separate and the circuit to open. For example, the prongs 584 and/or 588 can push the contact 564 into physical contact with the contact 562 when the plug is inserted into the socket.

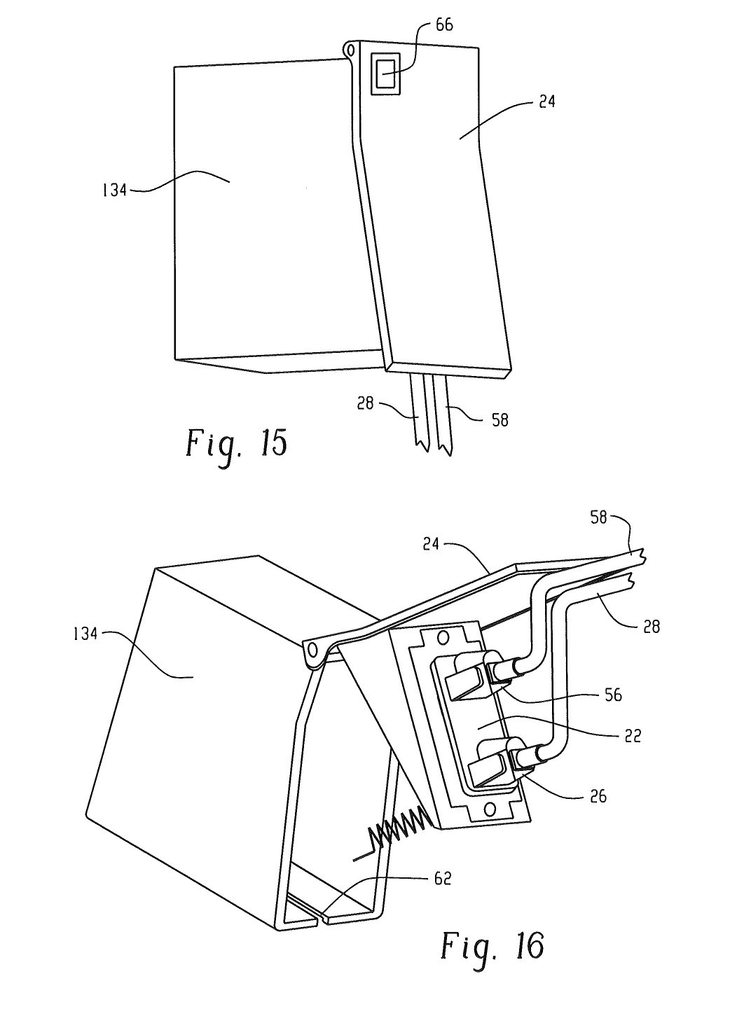

It is noted that the elements of the various embodiments can be combined and/or interchanged, so long as the combination does not adversely affect the functioning of the electrical box as intended. For example, the various switches, although discussed in separate embodiments, can be used alone or in combination. Also, the box can be designed such that multiple cords exit the box through a common opening 62 or separate openings 54, 60. In some embodiments, these openings can be designed to be sufficiently large to enable the cords to pass therethrough with the cover in the closed position, yet too small to enable the passage of a plug 26,56. The various embodiments can optionally comprise an external switch 66 on the junction box (see FIG. 15), e.g., a toggle switch, rocker switch, push button switch, rotary switch, snap-action switch, or the like, configured to switch the power to the receptacle and/or plug(s) on and off. Use of multiple external switches is also possible (e.g., two external switches), so that the power can separately be controlled to each plug without removing the plug from the receptacle. The various embodiments can also have contact(s) 68 that sense whether the cover is in the opened or closed position (e.g., a plunger contact that is depressed when the cover is closed).

Furthermore, the various embodiments can comprise a visual indicator (e.g., an electric and/or mechanical element) that can indicate whether the receptacle and/or an individual socket is active or inactive. Some exemplary indicators include light(s) (e.g., the light is on if the socket is active and off if the socket is inactive), window(s), such as with a colored plate(s), (e.g., a black colored plate is in the window if the socket is inactive and a red colored plate is in the window if the socket is active), lever(s) (e.g., the visible and/or oriented in a particular manner (e.g., up) if the socket is active and not visible and/or oriented in a different manner (e.g., down) off if the socket is inactive), as well as combinations that comprise at least one of the foregoing indicators.

The method of using these electrical outlets can comprise having an electrical box that is live, but the socket of the female electrical connector is dead (i.e., inactive). The prongs of a male electrical connector are inserted into the socket and then the socket is activated. In various embodiments, (i) electrically activating the socket comprises moving the electrical contacts together; (ii) moving the electrical contacts together comprises closing a cover of an electrical box; (iii) the female electrical connector is attached to a cover of an electrical box, and moving the electrical contacts together comprises closing the cover and moving the female electrical connector into the electrical box; (iv) moving the electrical contacts together comprises rotating the socket; (v) moving the electrical contacts together comprises compressing a switch on a surface of the female electrical receptacle; (vi) moving the electrical contacts together comprises engaging a magnetic switch; (vii) moving the electrical contacts together comprises pivoting the at least one electrical contact into physical contact with another electrical contact; (viii) moving the electrical contacts together comprises the prongs forcing the at least one electrical contact into physical contact engagement with another electrical contact to place the electrical contacts in the closed electrical circuit position; (ix) further comprise moving the electrical contacts to the open electrical circuit position by pushing the male electrical connector toward the socket to disengage a spring switch; (x) moving the electrical contacts together comprises moving the electrical contacts from a closed circuit position to an open circuit position and removing a barrier from the socket before inserting the male electrical connector; and/or (xi) removing the barrier comprises moving a switch from a rest position to an in-use position, wherein the switch automatically returns to the rest position when released.

As disclosed herein, in some embodiments, a female electrical connector can comprise: a socket having slots and electrical contacts, wherein at least one of the electrical contacts is movable between an open electrical circuit position where the electrical contacts are not in electrical communication and the socket is electrically inactive and a closed electrical circuit position where the electrical contacts are in electrical communication and the socket is electrically active. In another embodiment, a female electrical connector can comprise: a socket having slots a current interruption element (e.g. an element configured to interfere with the electrical circuit from electrical wiring to the socket), wherein when the socket is accessible and/or when prong(s) of a male electrical connector have not been inserted into the socket, the socket is electrically inactive, and when the socket is inaccessible and/or when the prong(s) have been inserted, the socket is electrically active. In the various embodiments, (i) the socket can be rotatable and rotation of the socket creates the relative motion between the electrical contacts; (ii) the connector further comprises a compressible switch in communication with the contacts, wherein the switch moves the electrical contacts from the open electrical circuit position to the closed electrical circuit position; (iii) the connector further comprises a magnetic switch in communication with the electrical contacts, wherein the switch moves the electrical contacts from the open electrical circuit position to the closed electrical circuit position when prongs of a male electrical connector are inserted into the slots; (iv) a pivot connected to the at least one electrical contact; and/or (v) the connector further comprises a visual indicator that indicates when the socket is electrically active.

In one embodiment, an electrical box can comprise: a container formed from a base having sides extending therefrom to define a cavity; and a female electrical connector comprising a socket having slots; and an internal switch, wherein the internal switch is configured to engage and disengage an electrical current to the socket while the electrical box remains electrically active. In the various embodiments, (i) the switch can comprise electrical contacts, wherein at least one of the electrical contacts is movable between an open electrical circuit position where the electrical contacts are not in electrical communication and the socket is electrically inactive and a closed electrical circuit position where the electrical contacts are in electrical communication and the socket is electrically active; (ii) the box can further comprise a cover configured to cover the cavity when in a closed electrical circuit position; wherein the female electrical connector is disposed in the container when the cover is in the closed electrical circuit position; and wherein opening the cover moves the at least one of the electrical contact; (iii) opening the cover can create relative movement between the female electrical connector and the container; (iv) the receptacle can further comprises a spring loaded ball bearing, wherein when the spring loaded ball bearing is in a resting state, the at least one electrical contact is in the open electrical circuit position, wherein, optionally, during opening and closing of the cover the spring loaded ball bearing traverses a path while the receptacle rotates on a central point; (v) the box can further comprise an opening in the at least one of the sides, configured to allow a cord to pass from within the cavity to outside the box when the cover is in the closed position, and wherein the opening is sufficiently small to inhibit the passage of a male electrical connector therethrough; (vi) the receptacle can be attached to the cover such that when the cover is in an open position, the receptacle is outside the cavity; (vii) the box can further comprise a switch, and wherein the female electrical connector further comprises a barrier that inhibits access into the slots; wherein the switch comprises a switch open position that enables access into the slots and orients the at least one electrical contact in the open electrical circuit position; (viii) the switch can comprise a spring mechanism configured to automatically return the switch to a switch closed position where the at least one electrical contact is in the closed electrical circuit position; and/or (ix) the box can further comprise a visual indicator in communication with the female electrical connector so as to indicate when a socket is electrically active (e.g., when the electrical contacts are in the closed electrical circuit position), optionally, the visual indicator can be a light.

“Combination” is inclusive of blends, mixtures, derivatives, alloys, reaction products, and so forth. Furthermore, the terms “first,” “second,” and so forth, herein do not denote any order, quantity, or importance, but rather are used to distinguish one element from another, and the terms “a” and “an” herein do not denote a limitation of quantity, but rather denote the presence of at least one of the referenced item. The suffix “(s)” as used herein is intended to include both the singular and the plural of the term that it modifies, thereby including one or more of that term (e.g., the receptacle(s) includes one or more receptacles). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and can or can not be present in other embodiments. In addition, it is to be understood that the described elements can be combined in any suitable manner in the various embodiments.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. An electrical box comprising:
a container formed from a base having sides extending therefrom to define a cavity; and
a female electrical connector comprising a socket having slots; and
an internal switch, wherein the internal switch is configured to engage and disengage an electrical current to the socket while the electrical box remains electrically active.

2. The electrical box of claim 1, wherein the switch comprises electrical contacts, wherein at least one of the electrical contacts is movable between an open electrical circuit position where the electrical contacts are not in electrical communication and the socket is electrically inactive and a closed electrical circuit position where the electrical contacts are in electrical communication and the socket is electrically active.

3. The electrical box of claim 2, further comprising a cover configured to cover the cavity when in a closed electrical circuit position; wherein the female electrical connector is disposed in the container when the cover is in the closed electrical circuit position; and wherein opening the cover moves the at least one of the electrical contact.

4. The electrical box of claim 3, wherein opening the cover creates relative movement between the female electrical connector and the container.

5. The electrical box of claim 4, wherein the receptacle further comprises a spring loaded ball bearing, wherein when the spring loaded ball bearing is in a resting state, the at least one electrical contact is in the open electrical circuit position.

6. The electrical box of claim 5, wherein during opening and closing of the cover the spring loaded ball bearing traverses a path while the receptacle rotates on a central point.

7. The electrical box of claim 1, further comprising an opening in the at least one of the sides, configured to allow a cord to pass from within the cavity to outside the box when the cover is in the closed position, and wherein the opening is sufficiently small to inhibit the passage of a male electrical connector therethrough.

8. The electrical box of claim 3, wherein the receptacle is attached to the cover such that when the cover is in an open position, the receptacle is outside the cavity.

9. The electrical box of claim 1, further comprising a switch, and wherein the female electrical connector further comprises a barrier that inhibits access into the slots; wherein the switch comprises a switch open position that enables access into the slots and orients the at least one electrical contact in the open electrical circuit position.

10. The electrical box of claim 9, wherein the switch comprises a spring mechanism configured to automatically return the switch to a switch closed position where the at least one electrical contact is in the closed electrical circuit position.

11. The electrical box of claim 1, further comprising a visual indicator in communication with the female electrical connector so as to indicate when the electrical contacts are in the closed electrical circuit position.

12. The electrical box of claim 11, wherein the visual indicator comprises a light.

13. A female electrical connector comprising: a socket having slots and electrical contacts, wherein at least one of the electrical contacts is movable between an open electrical circuit position where the electrical contacts are not in electrical communication and the socket is electrically inactive and a closed electrical circuit position where the electrical contacts are in electrical communication and the socket is electrically active.

14. The connector of claim 13, wherein the socket is rotatable and rotation of the socket creates the relative motion between the electrical contacts.

15. The connector of claim 13, further comprising a compressible switch in communication with the contacts, wherein the switch moves the electrical contacts from the open electrical circuit position to the closed electrical circuit position.

16. The connector of claim 13, further comprising a magnetic switch in communication with the electrical contacts, wherein the switch moves the electrical contacts from the open electrical circuit position to the closed electrical circuit position when prongs of a male electrical connector are inserted into the slots.

17. The connector of claim 13, further comprising a pivot connected to the at least one electrical contact.

18. A method for providing electricity to a male electrical connector, comprising:
inserting prongs of a male electrical connector into a socket of a female electrical connector, wherein the female electrical connector is connected to an electrical box, wherein the electrical box is electrically active and wherein the socket is electrically inactive; and
then electrically activating the socket.

19. The method of claim 18, wherein electrically activating the socket comprises moving electrical contacts together.

20. The method of claim 18, wherein moving the electrical contacts together comprises closing a cover of an electrical box.

21. The method of claim 18, wherein the female electrical connector is attached to a cover of an electrical box, and wherein moving the electrical contacts together comprises closing the cover and moving the female electrical connector into the electrical box.

22. The method of claim 18, wherein moving the electrical contacts together comprises rotating the socket.

23. The method of claim 18, wherein moving the electrical contacts together comprises compressing a switch on a surface of the female electrical receptacle.

24. The method of claim 18, wherein moving the electrical contacts together comprises engaging a magnetic switch.

25. The method of claim 18, wherein moving the electrical contacts together comprises pivoting the at least one electrical contact into physical contact with another electrical contact.

26. The method of claim 18, wherein moving the electrical contacts together comprises the prongs forcing the at least one electrical contact into physical contact engagement with another electrical contact to place the electrical contacts in the closed electrical circuit position.

27. The method of claim 26, further comprising moving the electrical contacts to the open electrical circuit position by pushing the male electrical connector toward the socket to disengage a spring switch.

28. The method of claim 18, wherein moving the electrical contacts together comprises moving the electrical contacts from a closed circuit position to an open circuit position and removing a barrier from the socket before inserting the male electrical connector.

29. The method of claim 28, wherein removing the barrier comprises moving a switch from a rest position to an in-use position, wherein the switch automatically returns to the rest position when released.
